(19) United States
(12) Patent Application Publication
(10) Pub. No.: US 2025/0256278 A1
(43) Pub. Date: Aug. 14, 2025

(54) LIQUID DELIVERY SYSTEM

(71) Applicant: Cellanome, Inc., Foster City, CA (US)

(72) Inventors: Tarun KHURANA, Fremont, CA (US); Behnam JAVANMARDI, Los Gatos, CA (US)

(21) Appl. No.: 19/189,056

(22) Filed: Apr. 24, 2025

Related U.S. Application Data
(63) Continuation of application No. PCT/US2023/077802, filed on Oct. 25, 2023.
(60) Provisional application No. 63/419,655, filed on Oct. 26, 2022.

(51) Int. Cl. B01L 3/00

(52) U.S. Cl. CPC B01L 3/50273; B01L 2200/0647; B01L 2200/0684; B01L 2200/0689; B01L 2200/12; B01L 2300/14; B01L 2400/049

(57) ABSTRACT

The methods and systems described herein are directed to a reagent delivery system for delivering multiple reagents from microwell arrays to reaction channels with a reduction of air gaps or bubbles or for removing cells not entrapped in hydrogel cages. In some embodiments, reagents are moved through a channel by a pump attached to a channel outlet and a pressure column applied to a channel inlet.

### CROSS REFERENCE

This application is a continuation of International Patent Application No. PCT/US2023/077802, filed Oct. 25, 2023, which claims the benefit of U.S. Provisional Application No. 63/419,655 filed Oct. 26, 2022, which is incorporated herein by reference in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BACKGROUND

Microfluidics has played a key role in technologies for single cell analysis, e.g. Zare et al, Annu. Rev. Biomed. Eng., 12: 187-201 (2010); Valihrach et al, Int. J. Mol. Sci., 19: 807 (2018); Murphy et al, The Analyst, 18: 60-80 (2017); Shinde et al, Int. J. Mol. Sci., 19: 3143 (2018); and the like. However, there are still challenges to designing fluidic and microfluidic systems that avoid common problems such as bubble formation, or bubble persistence once formed. Bubbles can negatively affect performance by hindering flow, blocking reaction areas, and damaging fragile microstructures, e.g. Pereiro et al, LabChip, 19: 2296 (2019). In particular, in systems where reagent storage, flow or transfer is in contact with ambient atmosphere, such reagents may accumulate dissolved gases that may exceed a saturation level and lead to bubble formation within microfluidic components.

### SUMMARY

In view of the above, the availability of new methods and apparatus for minimizing bubble formation in microfluidic systems processing fluids exposed to the atmosphere would advance the microfluidics field, especially in the area of single cell analysis.

The methods and systems described herein are directed to transferring liquid reagents from reservoirs exposed to atmosphere to fluidics systems where dissolved gases may be raised above saturation levels, thereby risking the formation of disruptive bubbles.

Provided herein is a method for moving a liquid in contact with atmosphere through a channel comprising: (a) providing a channel having an outlet and an inlet with an inlet reservoir, the channel containing a first liquid and being in fluid communication by its outlet with a pump that moves liquid through the channel at a predetermined rate; (b) transferring from a reservoir a second liquid in contact with atmosphere to the inlet reservoir of the inlet of the channel so that the transferred second liquid combines with the first liquid in the inlet reservoir; (c) attaching to the inlet reservoir a pressure manifold that provides a predetermined pressure above atmospheric pressure to the first and second liquids in the channel; and (d) moving the first and second liquids through the channel by the pump at the predetermined rate under the predetermined pressure. In some embodiments, moving the first and second liquids occurs for a predetermined duration such that the inlet reservoir is not emptied of the first and second liquids. In some embodiments, moving of the first and second liquids occurs for a predetermined duration such that a predetermined volume of the first and second liquids passes through the channel.

Also provided herein is a fluid delivery system comprising: (a) one or more reaction channels each containing a first liquid and having an outlet and an inlet with an inlet reservoir; (b) a pump for each of the one or more reaction channels, the pump being in fluid communication with the outlet of the reaction channel and capable of moving a liquid through the channel at a predetermined rate; (c) one or more supply reservoirs containing liquids in contact with atmosphere; (d) a pipettor for transferring a second liquid from the one or more supply reservoirs to the inlet reservoirs; and (e) a pressure manifold that is sealingly attached to the inlet reservoirs, the pressure manifold applying to the first and second liquids in the inlet reservoirs a predetermined pressure above atmosphere.

Also provided herein is a method of delivering reagents to a cell analysis system comprising: (a) providing a fluidic device comprising (i) a channel comprising an inlet, an outlet and a first surface having one or more cells disposed thereon, and wherein the inlet of the channel is in fluid communication with an inlet reservoir and the outlet of the channel is in fluid communication with a pump that draws or moves predetermined volumes of liquid in the inlet reservoir into the channel under programmed control; (b) loading the channel with an assay reagent in contact with atmosphere by transferring to the inlet reservoir a volume comprising the assay reagent; (c) sealingly attaching a pressure manifold to the inlet reservoir to pressurize the assay reagent at a predetermined pressure; and (d) drawing the assay reagent through the channel with the pump, so that the assay reagent combines with the one or more cells disposed on the first surface of the channel.

### BRIEF DESCRIPTIONS OF THE DRAWINGS

FIGS. 1A-1E illustrate embodiments for transferring liquids exposed to atmosphere to closed reaction channels of a fluidics system.

FIGS. 2A-2B illustrate in greater detail instruments which may employ the systems and methods described herein for detecting cells and synthesizing hydrogel chambers.

FIG. 3A is a photograph of various cells where some of the cells are caged into hydrogel structures and other cells are not caged and reside in the interstitial space in between the hydrogel structures.

FIG. 3B is a photograph of the various cells of shown in FIG. 3A after flowing a liquid through the flow cell without a pressure manifold that applies an overpressure while the pump moves fluid out of the channel and leaves behind a plurality of cells in the interstitial spaces.

FIG. 4A is a photograph of various cells where some of the cells are caged into hydrogel structures and other cells are not caged and reside in the interstitial space in between the hydrogel structures.

FIG. 4B is a photograph of the various cells shown in FIG. 4A after flowing a liquid through the flow cell with a pressure manifold that applies an overpressure while the pump moves fluid out of the channel. The proportion of cells left behind in the interstitial spaces was significantly less in FIG. 4B (with pressure manifold) compared to FIG. 3B (without pressure manifold).

FIG. 5A is a photograph of a flow cell having channels E and F both containing a liquid and relatively bubble free.

FIG. 5B is a photograph of the flow cell of FIG. 5A containing the liquid that was incubated at 42° C. for 90 minutes where channel F was pressurized with the pressure manifold at 5 PSI and channel E was at atmospheric pressure.

### DETAILED DESCRIPTION

The practice of the systems and methods described herein may employ, unless otherwise indicated, conventional techniques and descriptions of organic chemistry, molecular biology (including recombinant techniques), cell biology, and biochemistry, which are within the skill of the art. Such conventional techniques include, but are not limited to, preparation of synthetic polynucleotides, monoclonal antibodies, antibody display systems, cell and tissue culture techniques, nucleic acid sequencing and analysis, and the like. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV); PCR Primer: A Laboratory Manual; Retroviruses; and Molecular Cloning: A Laboratory Manual (all from Cold Spring Harbor Laboratory Press); Renault and Duchateau, Editors, Site-directed Insertion of Transgenes (Springer, Heidelberg, 2013); Lutz and Bornscheuer, Editors, Protein Engineering Handbook (Wiley-VCH, 2009); and the like. Guidance for selecting materials and components to carry out particular functions may be found in available treatises and references on scientific instrumentation including, but not limited to, Moore et al, Building Scientific Apparatus, Third Edition (Perseus Books, Cambridge, MA); Hermanson, Bioconjugate Techniques, 3rd Edition (Academic Press, 2013); and like references.

The methods and systems are directed to delivering fluids exposed to atmosphere, e.g. from open-air reservoirs, such as microwells, to closed reaction channels with minimal risk of inducing bubble formation in the channels. In one aspect, the method comprises transferring a liquid from a reservoir open to the atmosphere to an inlet reservoir at the inlet end of a reaction channel, after which a pressure manifold is sealingly attached to the inlet reservoir to deliver pressure to the liquids in the inlet channel and main channel. In some cases, at the outlet end main channel a pump or vacuum source draws or moves liquid through the reaction channel at a predetermined rate while at the same time the pressure manifold delivers a pressure to the inlet reservoir in excess of the ambient atmospheric pressure. In some embodiments, methods comprise a cycle of steps comprising (a) de-pressurizing a first liquid in a channel, (b) delivering a second liquid to an inlet reservoir in fluid communication with the channel so that the first and second liquids form a single liquid body, (c) pressurizing the first and second liquids, and (d) drawing at a predetermined rate the first and second liquids through the channel. In some embodiments, such liquid delivery is part of a process requiring a plurality of such transfers, in which case steps (a) to (d) may be repeated a plurality of times. In some embodiments, “de-pressurizing” means equilibrating the first liquid pressure with atmospheric pressure. In some embodiments, before de-pressuring, a first liquid is at a pressure higher than atmospheric pressure. In some embodiments, step (c) of pressurizing the first and second liquids comprises pressurizing the first and second liquid to a predetermined pressure. It should be noted that ambient pressure or ambient atmospheric pressure refers to the pressure at the location of the measurement and typically ranges from about 14.5 inches Hg to about 14.9 inches Hg (or 14.5 pounds per square inch (psi) to 14.9 pounds per square inch, and is typically about 14.7 psi).

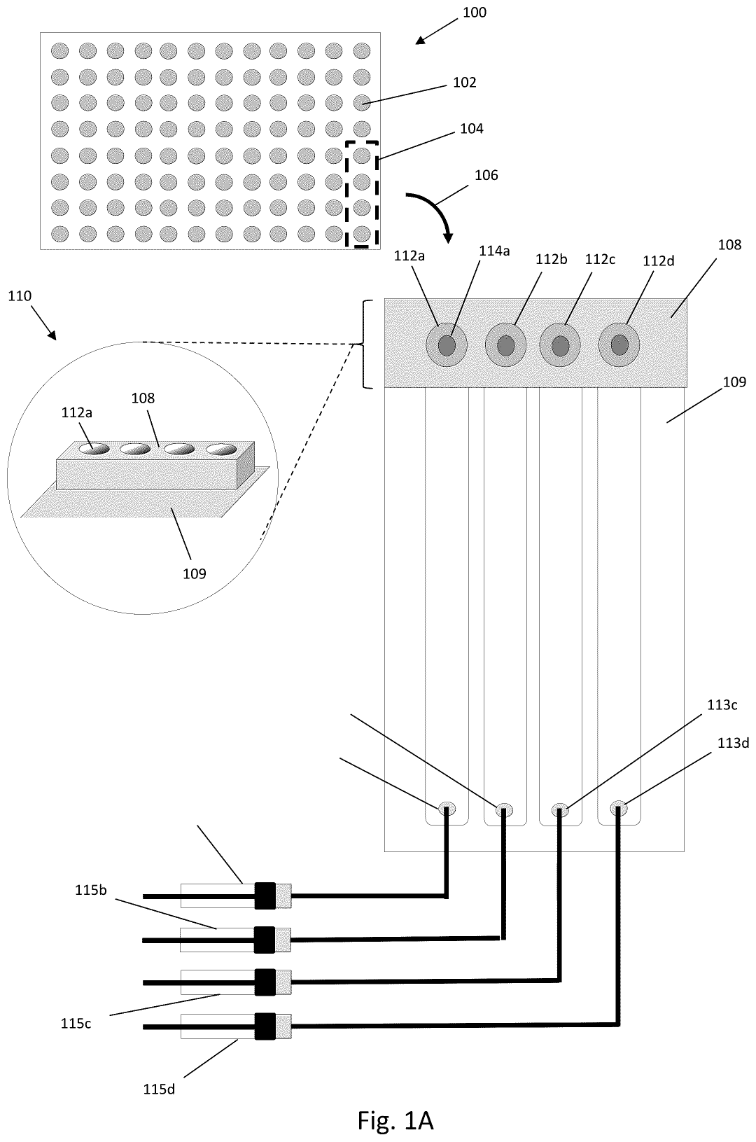

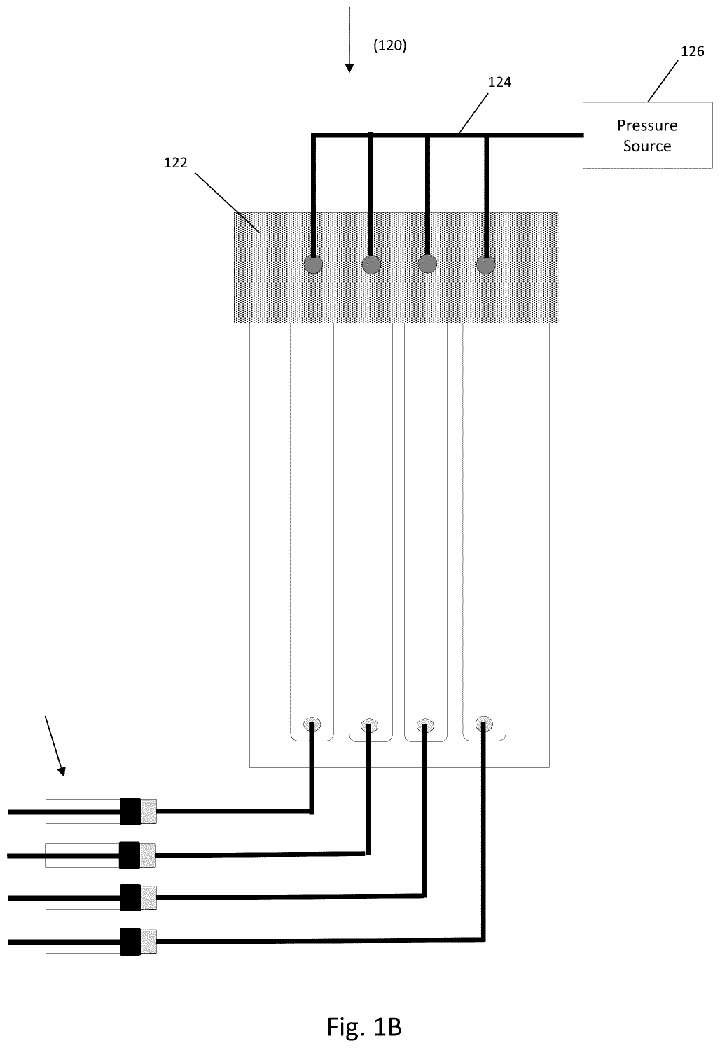

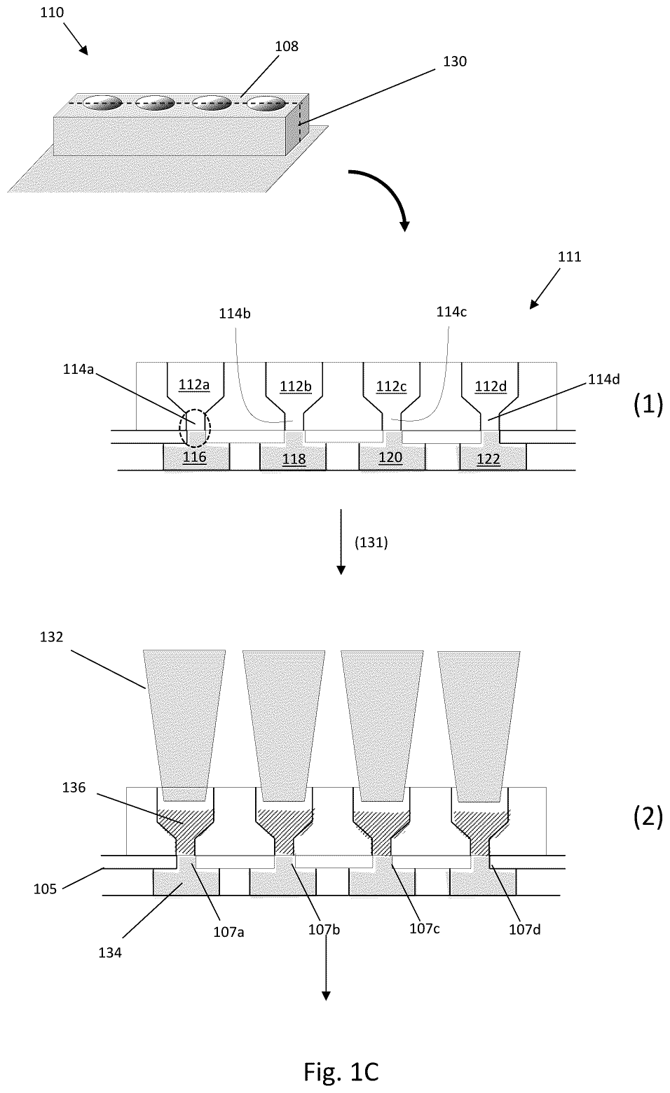

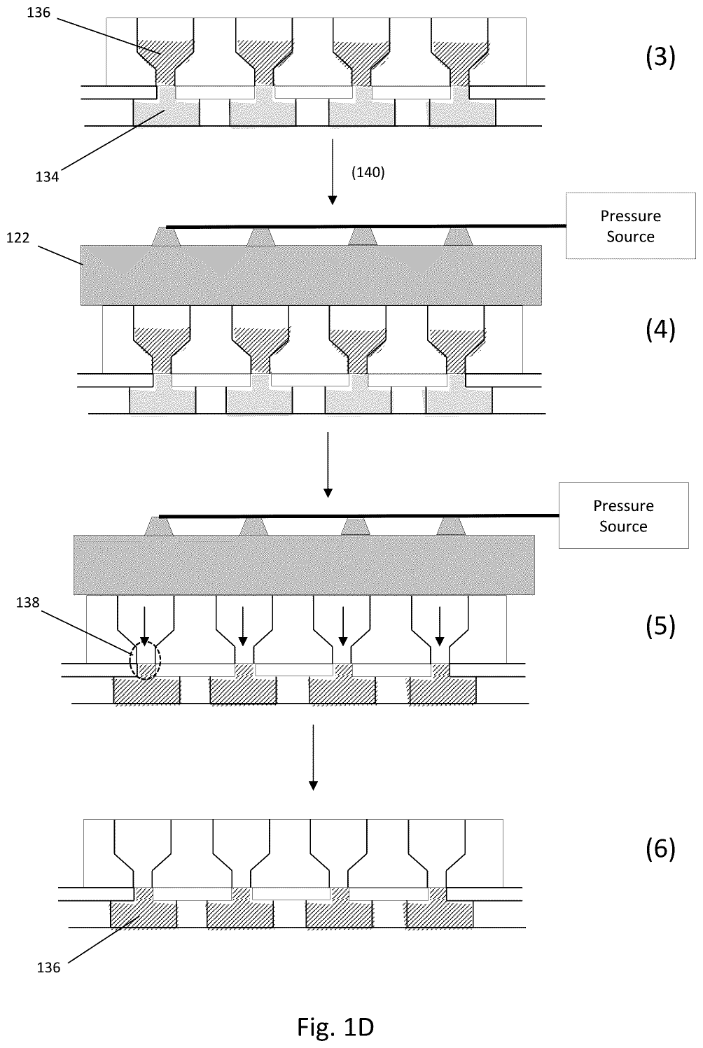

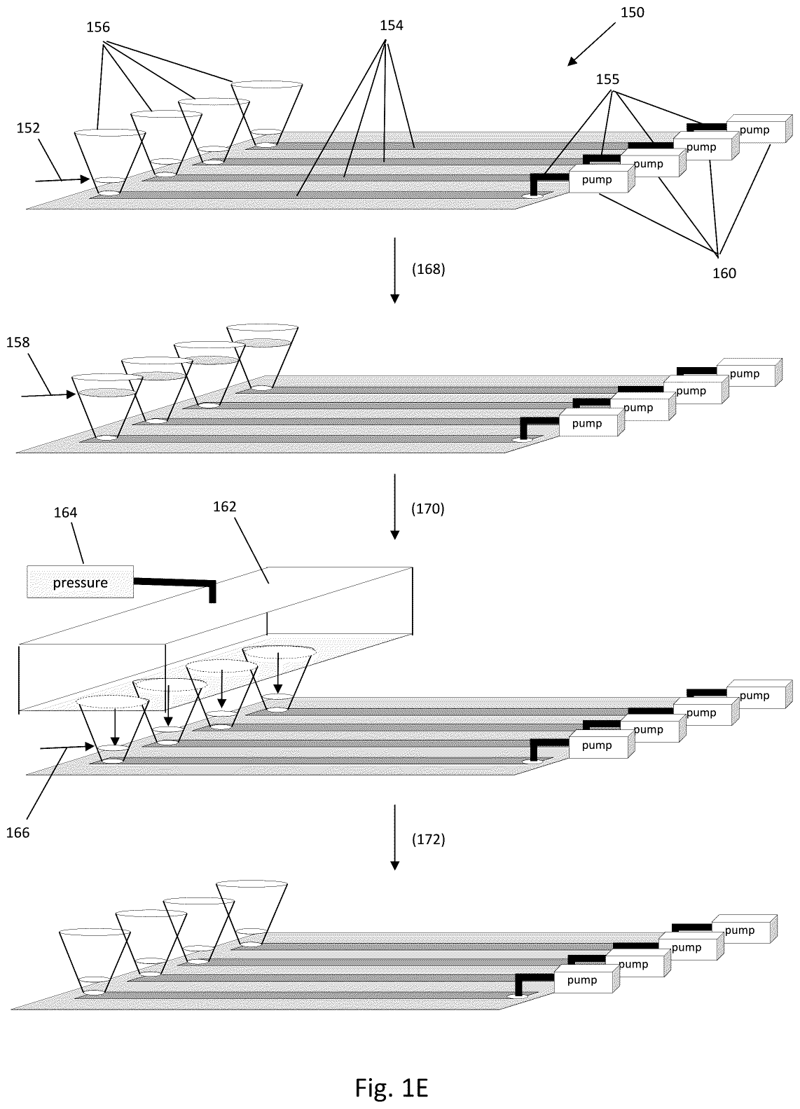

An embodiment of the method is illustrated in FIGS. 1A-1E. Flow cell (109) comprises four channels (116, 118, 120 and 122) (sometimes referred to as “main channels”) and body (108) comprising four inlet reservoirs (112a, 112b, 112c and 112d), one for each channel (116, 118, 120 and 122, respectively). In some embodiments, inlet reservoirs may comprise an inverted conical shape (or partial conical shape) as shown in FIGS. 1C or 1E, which inlet reservoirs are in fluid communication with channels (116, 118, 120 and 122, respectively) through the narrowed portions of the inverted cones (sometimes referred to herein as the “throats” of the inlet reservoirs, e.g. 114a of FIG. 1A) and the inlets of the respective channels. Inlet reservoirs may be formed in a body, such as (108) that is bonded to, or otherwise sealingly attached to, flow cell (109). Blow-up (110) gives a three-dimensional view of these components. Flow cell (109) can further include a first surface and a second surface to form a top boundary and bottom boundary of the channels. Referring to FIG. 1C, the first surface can be in the form of a glass sheet (105) that has a plurality of inlets (107a, 107b, 107c, and 107d) for the respective channels (116, 118, 120, and 122). The plurality of inlets (107a, 107b, 107c, and 107d) can be a series of through-holes in glass sheet (105) that align with the throat regions (114a, 114b, 114c, and 114d) of the inlet reservoirs (112a, 112b, 112c, and 112d). In various embodiments, a double-sided pressure sensitive adhesive having corresponding through-holes can be used for binding the body (108) to glass sheet (105) and the corresponding inlets (107a, 107b, 107c, and 107d). Channels (116, 118, 120 and 122) can each have an outlet (113a, 113b, 113c and 113d, respectively) at an end opposite of that of the inlet reservoirs. In some embodiments, each outlet reservoir (113a, 113b, 113c and 113d) are separately connected to (and in fluid communication with) a pump (115a, 115b, 115c and 115d, respectively). In some embodiments, such pumps are precision syringe pumps that may be programmed to draw or move liquids through their respective channels a predetermined flow rate at predetermined intervals in coordination with the filling of the inlet reservoirs (that is, for example, in some embodiments, the syringe pumps are inactive whenever the inlet reservoirs are being filled). Reagent reservoirs may be wells of a microtiter plate, such as a 96-well plate (100), where each well (e.g. 102) contains a reagent and a liquid transfer system, such as an automated pipetting system (that is, a “pipettor”), transfers liquids to all the inlet reservoirs of a flow cell at the same time. For example, in the four-channel flow cell of FIG. 1A, liquids of a subset of four wells (104) may be transferred (106) at the same time to the four inlet reservoirs (112a, 112b, 112c and 112d). As illustrated in FIG. 1B, after liquids are delivered to the inlet reservoirs, pressure manifold (122) is sealingly attached to the inlet reservoirs so that pressure may be applied to the delivered liquids and liquids already in the channels. Pressure manifold (122) may be a body that sealingly attaches to body (108) containing inlet reservoirs (112a, 112b, 112c and 112d). In some embodiments, each inlet reservoir may be pressurized using a separate pressure source, or in other embodiments, a single pressure source may pressurize all of the inlet reservoirs. In some embodiments, wherein each inlet reservoir is pressurized with a separate pressure source, such pressure source may be regulated to a pressure specific for its associated channel. In some embodiments, such specific pressure may depend on the amount of fluid resistance in its associated channel. Such differences in fluid resistance may arise from different amounts of material (e.g. cells, gel microstructures, debris, and the like) in the channel. The latter embodiment is illustrated in FIG. 1B. After pressure manifold (122) is sealingly attached to the inlet reservoirs, pressure source (126) can generate a pressure (or a predetermined pressure) which is transferred to the inlet reservoirs through conduits (124) and the pressure manifold itself. In some embodiments, the predetermined pressure is in excess of atmospheric pressure. In some embodiments, the predetermined pressure may be lower than atmospheric pressure, for example, under circumstances in which liquid is caused to flow from the channels to the inlet reservoirs.

FIGS. 1C and 1D further illustrate for the above embodiment, the movement of liquids through the inlet reservoirs and channels during operation of the fluid transfer system. Cross-sectional view (111) (or panel (1)) shows inlet reservoirs and channel interiors along plane (130)) transecting three-dimensional representation (110) of body (108) in which the inlet reservoirs are formed. Panels (2)-(6) present the same cross-sectional view at different steps in the fluid transfer process. Returning to panel (1), inlet reservoirs (112a, 112b, 112c and 112d) may be in fluid communication with interiors of channels (116, 118, 120 and 122, respectively) through throat regions of inlet reservoirs (114a, 114b, 114c and 114d, respectively), which each comprises the narrowed region of the inlet reservoir and the inlet of the channel (specifically shown for inlet reservoir 114a). The shaded region of the channels and channel inlets in cross-section (111) indicates the presence of a first liquid. From the configuration of cross-section (111) (i.e., first liquid in channel, inlet reservoir empty (or nearly empty)), as shown in panel (2), second fluids may be transferred (131) from an open reservoir (or reservoirs) to the open inlet reservoirs, for example, by the use of pipettes (132). After removal of pipettes (132) (panel (3)), first liquid (134) and second liquid (136) are shown may combine, or coalesce, with one another (at least locally) so that they form a single body of liquid for each channel. Pressure manifold (122) may be sealing attached (140) to inlet reservoirs (112a, 112b, 112c and 112d); a predetermined pressure may be applied to the inlet reservoirs; and pumps (115a, 115b, 115c and 115d) may be activated to begin drawing liquid through their respective channels are a predetermined rate (panels (4) and (5)). In some embodiments, the pressure is regulated if necessary to maintain the predetermined pressure as the first and second liquids are moved through the channels by the pumps. In some embodiments, the amount of liquid drawn through a channel is greater than a single channel volume. In some embodiments, the amount of liquid drawn or moved through a channel is a multiple of the channel volume. For example, the amount of liquid drawn or moved through a channel can be 2×, 3×, 4×, 5×, or 10× the channel volume. In some embodiments, the amount of liquid drawn or moved through a channel may be less than a single channel volume. The volume of the inlet reservoirs (and the volumes of liquid delivered to them) can be adjusted depending on the predetermined volumes of liquid desired to be drawn or moved through the channels. In some embodiments, the volumes of liquid delivered and the volumes of liquid drawn or moved in each cycle of steps represented in panels (1) to (6) is selected so that after liquid is drawn or moved, the resulting level of liquid in the inlet reservoir is within or above the throat region of the inlet reservoir (e.g. illustrated by (138) of panel (5) of FIG. 1D, or by (152) or (166) in FIG. 1E). Finally, as shown in panel (6), the original first liquid (shown as shaded region (134) in panel (3)) can be replaced by the new first liquid (shown as the cross-hatched region (136) in panel (6)), so that the inlet reservoirs are ready for the next cycle of liquid transfer steps.

FIG. 1E also illustrates the cycle of steps in the transfer a volume of liquid by methods described herein. Flow cell (150) is shown with inlet reservoirs (156) in fluid communication with channels (154) and pumps (160) by way of conduits (155) connecting channel outlets to pumps (160). At the beginning of a transfer cycle, level (152) of the first liquid can be in or near the throat region of the inlet reservoir or the inlet of the channel. A second liquid may be transferred (168) to the inlet reservoir, thereby raising level (158) of the combined first and second liquids in the inlet reservoir. Pressure manifold (162) (connected to pressure source (164)) may be sealingly attached (170) to the inlet reservoirs, and a predetermined pressure can be applied to the first and second liquids, after which pumps (160) are activated (170) to draw or move a predetermined volume of the first and second liquids through channels (154), thereby bringing the first and second liquid level to (166), which makes the system ready (172) for the next liquid transfer cycle.

### APPLICATIONS

The reagent delivery method and system described herein may be used with a wide range of analytical devices, particularly devices for analyzing living biological materials, such as single cells, because of the susceptibility to disruption and/or distortions of measurements or manipulations by the formation and movement of bubbles. The reagent delivery method and system described herein may be particularly applicable to cell analysis systems employing gel microstructures in flow cell channels, such as described in Khurana et al, International patent publication WO2022/150659, which is incorporated herein by reference.

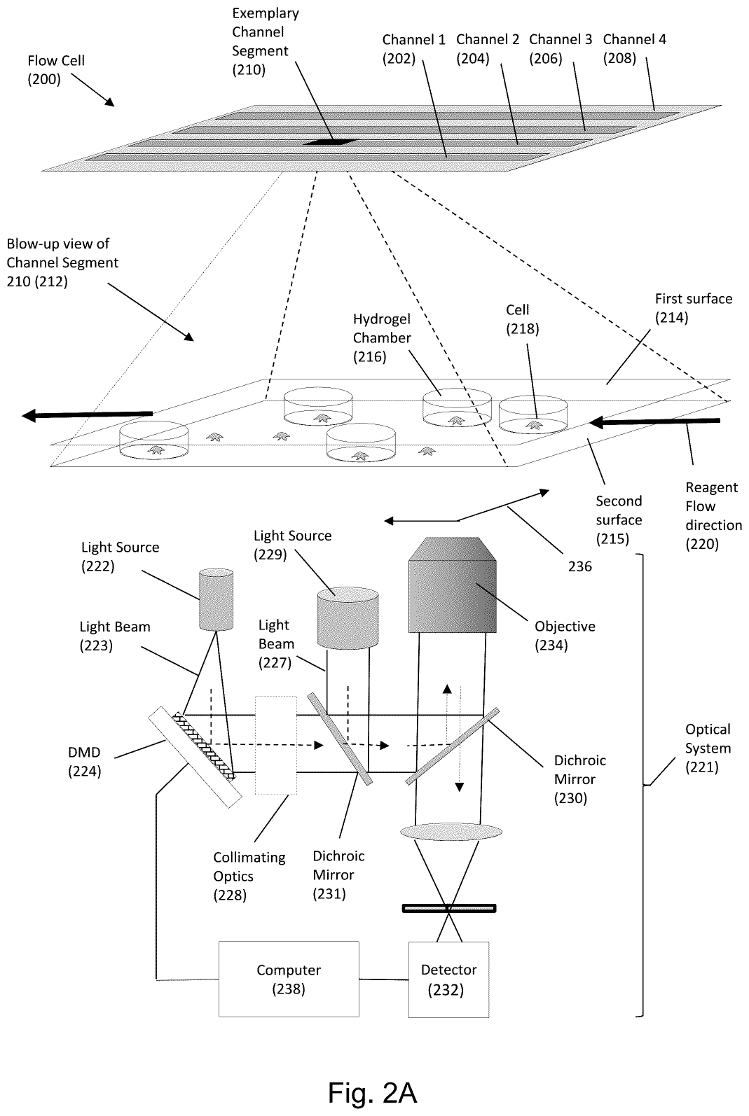

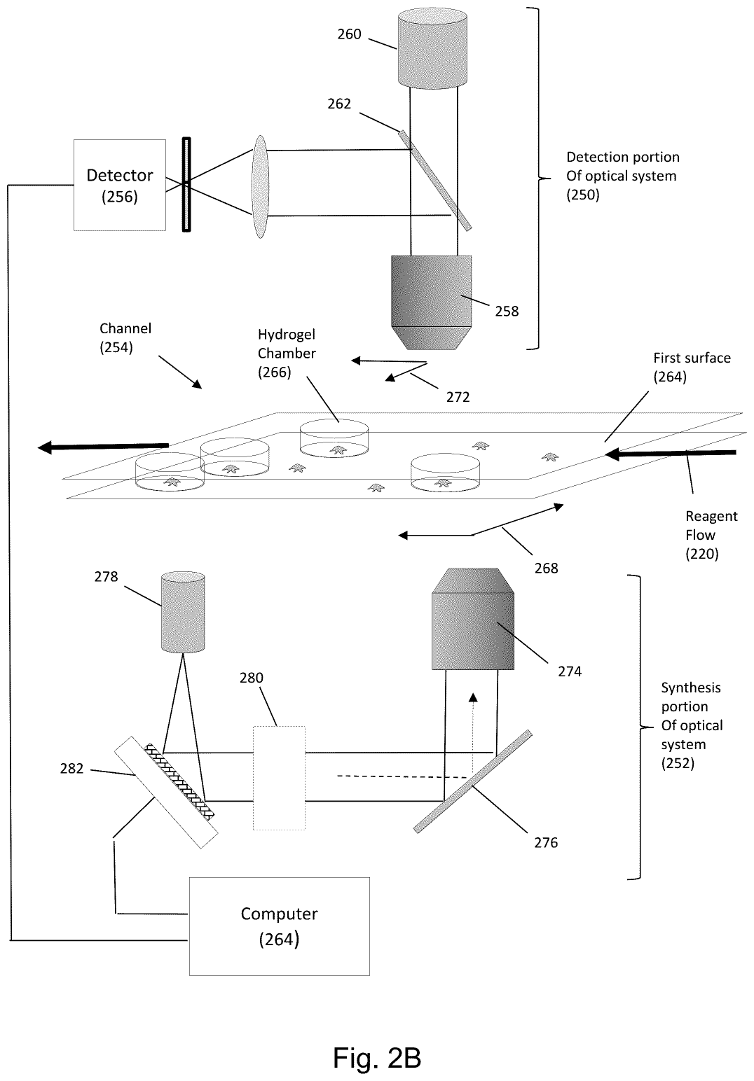

FIGS. 2A-2B illustrate channels of flow cells made and operated in accordance with Khurana et al (cited above). Flow cell (200) may be a component of a fluidic device that provides one or more channels and liquid handling components under programmable control for delivering beads and reagents to the channels. In this illustration, four channels (202, 204, 206, and 208) are shown, with blow-up view (212) of segment (210) of channel 2 (204) shown below. In the abstracted view of flow cell (200) of FIG. 2A, inlets, outlets and other features of the channels are not shown. In some embodiments, the distance between the lower surface (“first” surface, 214) and the upper surface (“second” surface, 215) (i.e., the interior height of the channels) may be in the range of from 10 μm to 500 μm, or in the range of from 50 μm to 250 μm. On first surface (214) of channel 2 (204) a plurality of cells, e.g. (218), are each enclosed by a hydrogel chamber, e.g. (216). In some cases, a portion of the plurality of cells are each enclosed by a hydrogel chamber. In some embodiments, the porosity of polymer matrix walls of the hydrogel chambers is selected to be impermeable to the cells, but permeable to reagents for forming spatial barcodes. Thus, reagents may be introduced to, and removed from, the interiors of the hydrogel chambers by flowing (220) them through the channels, but beads are retained inside. Below blow-up (212) of channel segment (210) is shown an optical system (221) for photosynthesizing hydrogel chambers at the locations of cells in the channels, for example, as disclosed in Khurana et al (cited above). Optical systems with different configurations than those of FIGS. 2A and 2B may be employed for carrying out these functions. In some embodiments, one or more digital micromirror device (DMD)-objective subsystems for synthesizing hydrogel structures may be employed to increase the speed of synthesis by synthesizing multiple structures simultaneously.

Returning to FIG. 2A, for photosynthesizing the hydrogel chambers, light source (222) may generate a light beam (223) of appropriate wavelength light (e.g. UV light), that passes through an appropriate photo-mask or beam-shaping or beam steering (Galvo) system for shaping a beam, to synthesize a desired structure or structures in a channel. In some embodiments, a digital micromirror device (DMD) (224) is employed. In some embodiments, a physical photomask may be employed. Chamber position, shape and polymer matrix wall thickness may be determined at least in part from position information determined from images collected by detector (232). The position information can be the position of a cell, nucleic acid, or any analyte of interest. Reflected light from DMD (224) may be shaped using optics, e.g. collimating optics (228), and is directed through objective lens system (234) into channel 2 segment (210). Objective (234) and flow cell (200) can move relative to one another in the xy-directions (236) to photosynthesize chambers at any position in any of the channels. In some embodiments, flow cell (200) moves and optical system (221) is stationary. In some embodiment, objective (234) may also direct light beam (227) from light source (229) to targets, such as cells, on first surface (214) and collect optical signals, such as fluorescent signals, from assays taking place on first surface (214). Alternatively, optical signal collection may be carried out with a separate objective as shown in FIG. 2B. Information collected by detector (232), or its counterpart in the embodiment of FIG. 2B, particularly cellular positions in their respective channels, may be employed by computer (238) and/or subsidiary controllers to direct DMD (224) and translation devices controlling the relative positions of objective (234) and flow cell (200) to synthesize hydrogel chambers of the appropriate shape and size at the appropriate locations.

FIG. 2B illustrate an alternative optical system in which the detection portion (250) of the optical system moves (272) independently from the movement (268) of the synthesis portion (252) of the optical system. Detection portion (250) of the optical system comprises detector (256), objective (258), light source (260) and interconnecting optical elements, such as dichroic mirror (262). As with the embodiment of FIG. 2A, detector (256) is operationally associated with computer (264) and the synthesis portion (252) of the optic system to provide synthesis portion (252) with position information. Computer (264) and (238) are also in operationally associated with stages and/or motors controlling the relative positions of the objectives of the optical systems and the position of the flow cell. In this embodiment, synthesis portion (252) of the optical system is located on the other side of first surface (264) from detection portion (250). As with the embodiment of FIG. 2A, it comprises the components objective (274), mirror (276), collimating optics (280), DMD (282) and light source (278).

In some embodiments, methods and systems for single cell analysis employing reagent delivery subsystems comprise (a) providing a fluidic device comprising (i) a channel comprising an inlet, an outlet and a first surface having one or more cells disposed thereon, and wherein the inlet of the channel is in fluid communication with an inlet reservoir and the outlet of the channel is in fluid communication with a pump that draws or moves predetermined volumes of liquid in the inlet reservoir into the channel under programmed control; (b) loading the channel with an assay reagent in contact with atmosphere by transferring to the inlet reservoir a volume comprising the assay reagent; (c) sealingly attaching a pressure manifold to the inlet reservoir to pressurize the assay reagent at a predetermined pressure; and (d) drawing the assay reagent through the channel with the pump, so that the assay reagent combines with the one or more cells disposed on the first surface of the channel. In some embodiments, such methods further include incubating the one or more cells and the assay reagent for a predetermined time. In some embodiments, such assay reagent is a cell lysing reagent, a transcription reagent, a polynucleotide amplification reagent.

In some embodiments, methods and systems for single cell analysis employing reagent delivery subsystems comprise (a) providing a fluidic device comprising (i) a channel comprising an inlet, an outlet and a first surface, (ii) a spatial energy modulating element in optical communication with the first surface, (iii) a detector that identifies positions of one or more cells in the channel based on one or more optical signals therefrom, wherein the inlet of the channel is in fluid communication with an inlet reservoir and the outlet of the channel is in fluid communication with a pump that draws under programmed control predetermined volumes of liquid in the inlet reservoir through the channel; (b) loading the channel with one or more cells by transferring to the inlet reservoir a volume of a mixture of one or more cells and one or more polymer precursors, sealingly attaching a pressure manifold to the inlet reservoir to pressurize the mixture at a predetermined pressure, and drawing the mixture through the channel with the pump at a predetermined rate, so that cells of the mixture are disposed on the first surface of the channel; (c) synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein the position of each of the synthesized chambers on the first surface is determined by the position of a cell enclosed thereby identified by the detector.

In some embodiments, methods and systems for single cell analysis employing reagent delivery subsystems comprise (a) providing a fluidic device comprising (i) a channel comprising an inlet, an outlet and a first surface having one or more cells disposed thereon, (ii) a spatial energy modulating element in optical communication with the first surface, (iii) a detector that identifies positions of one or more cells in the channel based on one or more optical signals therefrom, wherein the inlet of the channel is in fluid communication with an inlet reservoir and the outlet of the channel is in fluid communication with a pump that draws under programmed control predetermined volumes of liquid in the inlet reservoir into the channel; (b) loading the channel with one or more polymer precursors by transferring to the inlet reservoir a volume of a liquid comprising the one or more polymer precursors, sealingly attaching a pressure manifold to the inlet reservoir to pressurize the liquid at a predetermined pressure, drawing the liquid through the channel with the pump, so that the one or more polymer precursors combine with the one or more cells disposed on the first surface of the channel; (c) synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein the position of each of the synthesized chambers on the first surface is determined by the position of a cell enclosed thereby identified by the detector.

It is understood that the term “detector” as used herein may include, but not be limited by, a microscope element that collects and optionally magnifies an image of a portion of a channel and an image analysis element that comprises software for identifying cells and associated position information. A computer element uses such information generated by a detector together with user input to generate commands for other elements, such as, the spatial energy modulating element to carry out a variety of functions including, but not limited to, synthesizing chambers, “on-demand” degrading of chambers, selectively photo-degrading chambers, and the like. Configurations of such embodiments are illustrated in FIGS. 2A-2B which are described above. In some embodiments, a channel of a fluidic device further comprises a second surface wherein said first surface and the second surface are disposed opposite one another across the channel, and wherein the polymer matrix walls of the chambers extend from the first surface to the second surface to form chambers each having an interior. In some embodiments, chambers in a channel each enclose a single cell. In some embodiments both the first wall and the second wall are made of optically transmissive materials, such as, glass, plastic, or the like, and are positioned so that the first surface and second surface are substantially parallel to one another. The perpendicular distance between a first surface and a second surface may be in the range of from 10 μm to 500 μm, or in the range of from 50 μm to 250 μm.

As noted above, any of first surfaces, second surfaces or polymer matrix wall of chambers may comprise capture elements and other functional groups for carrying out a variety of operations including, but not limited to, capturing beads, capturing cells, capturing analytes (such as, mRNA, secreted proteins, intracellular proteins, or genomic sequences), capturing constituents of analytical reagents (such as, oligonucleotide labels from antibodies), and the like. Derivatizing surfaces for such purposes is well-known to those skilled in the art, as evidenced by the following references: Integrated DNA Technologies brochure (cited above); Hermanson (cited above); and the like.

As noted above, in some embodiments, a fluidic device of the method comprises or is operationally associated with a detector that either may share an optical path of the spatial energy modulating element or may be disposed adjacent to the second wall or opposite the first wall from the spatial energy modulating element in embodiments, such as wells, that have only a first wall and first surface. The detector is positioned so that it is capable of detecting optical signals from or adjacent to cells in the channel, for example, distributed over the first surface in chambers. In some embodiments, the first and second walls each comprise optically transmissive material, for example, so that a spatial energy modulating element may project light energy to the interior of the channel, and so that a detector may detect optical signals, such as fluorescent emissions or reflected light from biological components. In some embodiments, the projected energy from the spatial energy modulating element is a light energy from a light beam. In some embodiments, the light beam projected by the spatial energy modulating element may have a complex cross-section that permits (in various embodiments) the simultaneous synthesis of a plurality of chambers. Optically transmissive materials include, but are not limited to, glass, quartz, plastic, and like materials.

Spatial energy modulating elements using light energy for polymerization may comprise physical photomasks or virtual photomask, such as, a digital micromirror device (DMD). The following references, which are hereby incorporated by reference, provide guidance in selecting and operating a DMD for photopolymering gels; Chung et al, U.S. Pat. No. 10,464,307; Hribar et al, U.S. Pat. No. 10,351,819; Das et al, U.S. Pat. No. 9,561,622; Huang et al, Biomicrofluidics, 5: 034109 (2011); and the like.

### Gel Chambers

Methods and apparatus of Khurana et al may employ a wide variety of photo-synthesizable gels and degradable gels for cellular analysis. Guidance for selecting such gels for desired properties including, but not limited to, biocompatibility, porosity, gelation speed, degradation speed, and like properties, is provided in the following references, which are incorporated by reference; Kharkar et al, Chem. Soc. Rev., 42: 7335-7372 (2013); Kharkar et al, Polymer Chem., 6(31): 5565-5574 (2015); Neumann et al, Acta Biomater., 39: 1-11 (2016); DeForest et al, Nature Chemistry, 3(12): 925-931 (2012); Bowman et al, U.S. Pat. No. 9,631,092; LeValley et al, ACS Appl. Bio. Mater., 3(10): 6944-6958 (2020); Kabb et al, ACS Appl. Mater. Interfaces, 10: 16793-16801 (2018); Fairbanks et al, Macromolecules, 44: 2444-2450) (2011); Fairbanks et al, Adv. Mater., 21(48): 5005-5010 (2009); Sugiura et al, U.S. patent publication US2016/0177030; Shih et al, Biomacromolecules, 13(7): 2003-2012 (2012); and the like. In some embodiments, photo-synthesized gels are formed using a photo-initiator for radical polymerization. In some embodiments, photo-initiators comprise Irgacure 2959, Lithium phenyl-2,4,6-trimethylbenzoylphosphinate (LAP), or Eosin-Y (e.g. see Choi et al, Biotechniques, 66(1): 40-53 (2019)). In some embodiments, hydrogel precursors comprise hyaluronic acid, chitosan, heparin, alginate, polyethylene glycol (PEG), multi-arm PEG, poly(ethylene glycol) -b-poly(propylene oxide)-b-poly(ethylene glycol) (PEG-PPO-PEG), poly(lactic acid-co-glycolic acid)-b-poly(ethylene glycol)-b-poly(lactic acid-co-glycolic acid) (PLGA-PEG-PLGA), and poly(vinyl alcohol). In some embodiments, polymer precursors comprise PEG or multi-arm PEG. In some embodiments, polymer precursors comprise an enzymatically degradable cross-linker. In some embodiments, such enzymatically degradable cross-linker is degradable by an esterase or a peptidase. In some embodiments, polymer precursors comprise a photo-degradable cross-linker. In some embodiments, such photo-degradable cross-linker comprises a nitrobenzyl group. In some embodiments, such photo-degradable cross-linker comprises a courmarin moiety. In some embodiments, photo-degradable hydrogels are used with methods described herein, for example, because photo-degradation of hydrogel chambers may be carried out selectively and on-demand, so that specified hydrogel chambers may be degraded without affecting non-selected hydrogel chambers are unaffected. In some embodiments, hydrogel chambers are degraded non-selectively, so that all hydrogel chambers in a given channel (or other vessel) are degraded simultaneously. In some embodiments, such non-selective degradation is carried out with a cleavage reagent that specifically cleaves a labile bond in a hydrogel. For example, such cleavage agent comprises a reducing agent. In some embodiments, such non-specific degradation is carried out with an enzyme that cleaves a bond or chemical element in a hydrogel. Chemical elements include, but are not limited to, peptides, polysaccharides and oligonucleotides.

In the figures, for convenience, hydrogel chambers are illustrated as standing in isolation without connection with adjacent chambers and as having a cylindrical or annular-like shapes; however, a spatial energy modulating element may synthesize chambers of different shapes and sizes, as is useful for particular applications. In some embodiments of the proliferation assay, each hydrogel chamber synthesized has the same shape and area, for example, annular-like with an interior area selected from the range of 0.001 to 0.01 mm².

Porosity. In some embodiments, hydrogel porosity is selected to permit passage of selected reagents while at the same time preventing the passage of other reagents or objects, such as, a cell or proteins of a lysed cell. In some embodiments, crosslinking the polymer chains of the hydrogel structure forms a hydrogel matrix having pores (i.e., a porous hydrogel matrix). In some embodiments, the pores have an average diameter of from about 2 nm to about 25 nm, or from about 5 nm to about 20. In some embodiments, average pore diameters are selected to prevent the passage of cellular proteins. In some embodiments, average pore diameters are selected to prevent the passage of cellular proteins having a molecular weight of 1 kiloDaltons or greater. In some embodiments, average pore diameters are selected to prevent the passage of cellular proteins having a molecular weight of 5 kiloDaltons or greater. In some embodiments, the pore size of the hydrogel structures is tuned by varying the ratio of the concentrations of polymer precursors to the concentration of crosslinkers, varying pH, salt concentrations, temperature, light intensity, and the like. Guidance for selecting materials and conditions to control hydrogel porosity may be found in the following references; Jung et al, Biochem. Eng. J., 135: 123-132 (2018); Winther et al, Biochim. Biophys. Acta. 1840(2); doi: 10.1016/j.bbagen.3013.03.031 (2014); Annabi et al, Tissue Engineering, part B, 16(4): 371-383 (2010); and the like.

Size and Shape of Hydrogel Chambers. In some embodiments, a polymer matrix wall of a chamber inhibits passage of a predetermined component, such as a mammalian cell, a bacterial cell, or proteins from a lysed cell. In some embodiments, a polymer matrix wall extends from the first surface to a second surface (parallel to the first surface) to form a chamber within a channel. In some embodiments, a chamber has polymer matrix walls and an interior. In some embodiments, the interior of a chamber is sized for enclosing a cell, such as a mammalian cell. For example, such chamber may comprise a cylindrical shell or a polygon shell, comprising an inner space, or interior and a polymer matrix wall. In some embodiments, such chambers may have annular-like cross-sections. As used herein, the term “annular-like cross-section” means a cross-section topologically equivalent to an annulus. In some embodiments, the inner space, or interior, of a chamber has an inner diameter from 1 μm to 500 μm and a volume in the range of from 1 pico liter to 200 nano liters, or from 100 pico liters to 100 nano liters, or from 100 picoliters to 10 nano liters. In some embodiments, the polymer matrix wall has a thickness of at least 1 μm (micrometer). In some embodiments, the height of a chamber with an annular-like cross section have a value in the range of from 10 μm to 500 μm, or in the range of from 50 μm to 250 μm. In some embodiments, a polymer matrix wall having an annular-like cross-section has an aspect ratio (i.e., height/width) of 1 or less. In some embodiments, aspect ratio and polymer matrix wall thickness are selected to maximize chamber stability against forces, such as reagent flow through the channel, washings, and the like. In some embodiments, the at least one polymer matrix wall is a hydrogel wall. In some embodiments, the at least one polymer matrix is degradable. In some embodiments, the degradation of the at least one polymer matrix is “on demand.” In some embodiments, chambers in a channel are non-contiguous. In some embodiments, chambers in a channel may be contiguous with adjacent chambers. In some embodiments, chambers may share polymer matrix walls with one another. In some embodiments, chambers may be synthesized with slits or other orifices large enough to permit passage of certain components, e.g. beads, but small enough to prevent passage of other components, e.g. cells.

Hydrogel Compositions. As mentioned above, hydrogel compositions may vary widely and hydrogels may be formed by a variety of methods. Biocompatible hydrogel precursors comprise, but are not limited to, hyaluronic acid, chitosan, heparin, alginate, polyethylene glycol (PEG), multi-arm PEG, poly(ethylene glycol)-b-poly(propylene oxide) -b-poly(ethylene glycol) (PEG-PPO-PEG), poly(lactic acid-co-glycolic acid)-b-poly(ethylene glycol)-b-poly(lactic acid-co-glycolic acid) (PLGA-PEG-PLGA), and poly(vinyl alcohol). In some embodiments, hydrogels are formed by photo-initiated free radical crosslinking. In some embodiments, hydrogels are formed by photo-initiated thiol-ene reactions.

Hydrogel Degradation. In some embodiments, hydrogel chambers are degradable or depolymerizable either generally within a channel or “on demand” within a channel. Hydrogel chambers that are generally degradable are degraded by treatment with a degradation agent, or equivalently, a depolymerization agent that is exposed to all chambers within channel. Depolymerization agents include, but are not limited to, heat, light, and/or chemical depolymerization reagents (also sometimes referred to a cleaving reagents or degradation reagents). In some embodiments, on demand degradation may be implemented using polymer precursors that permit photo-crosslinking and photo-degradation, for example, using different wavelengths for crosslinking and for degradation. For example, Eosin Y may be used for radical polymerization at defined regions using 500 nm wavelength, after which illumination at 380 nm can be used to cleave the cross linker. In other embodiments, photo-caged hydrogel cleaving reagents may be included in the formation of polymer matrix walls. For example, acid labile crosslinkers (such as esters, or the like) can be used to create the hydrogel and then UV light can be used to generate local acidic conditions which, in turn, degrades the hydrogel. In some embodiments, the at least one polymer matrix is degradable by at least one of: (i) contacting the at least one polymer matrix with a cleaving reagent; (ii) heating the at least one polymer matrix to at least 90° C.; or (iii) exposing the at least one polymer matrix to a wavelength of light that cleaves a photo-cleavable cross linker that cross links the polymer of the at least one polymer matrix. In some embodiments, the at least one polymer matrix comprises a hydrogel. In some embodiments, the cleaving reagent degrades the hydrogel. In some embodiments, the cleaving reagent comprises a reducing agent, an oxidative agent, an enzyme, a pH based cleaving reagent, or a combination thereof. In some embodiments, the cleaving reagent comprises dithiothreitol (DTT), tris(2-carboxyethyl)phosphine (TCEP), tris(3-hydroxypropyl)phosphine (THP), or a combination thereof. In some embodiments, the surface of the polymer matrix or hydrogel may be functionalized by coupling a functional group to the polymer matrix or hydrogel.

While the methods and systems have been described herein with reference to several particular example embodiments, those skilled in the art will recognize that many changes may be made thereto without departing from the spirit and scope of the present disclosure. The methods and systems described herein can be applicable to a variety of sensor implementations and other subject matter, in addition to those discussed above.

### ADDITIONAL EMBODIMENTS

Aspect 1. A method for moving a liquid through a channel, comprising:

(a) providing the channel having an outlet and an inlet, wherein an inlet reservoir is fluidically coupled to the inlet, the channel containing a first liquid and being in fluid communication with the outlet, wherein a pump is fluidically coupled to the outlet, the pump being configured to move the liquid through the channel;

(b) transferring a second liquid to the inlet reservoir, wherein the transferred second liquid is in contact with an atmosphere;

(c) attaching to the inlet reservoir a pressure manifold that provides a pressure above atmospheric pressure to the first and the second liquids; and

(d) actuating the pump to withdraw at least a portion of the first liquid from the channel via the outlet and to move at least a portion of the second liquid into the channel, wherein the pump was programmed to move fluid at a predetermined rate while under the provided pressure.

In various aspects described herein, the first liquid can include a buffer (e.g., phosphate buffer saline), various types of cells, and/or polymer precursor configured to polymerize into cell cages.

In various aspects described herein, the second liquid can include a buffer (e.g., phosphate buffer saline), lysing agents, fluorescently tagged antibodies, cellular media, and/or a hydrogel degrading agent.

In various aspects described herein, the pressure can be a constant value, a predetermined value, a range of pressure values, or an overpressure value greater than ambient atmospheric pressure.

Aspect 2. The method of Aspect 1, wherein the pressure manifold provides the pressure above the atmospheric pressure before the actuating the pump to withdraw the first and second liquids through the channel.

Aspect 3. The method of Aspect 1, wherein the pressure manifold provides the pressure above the atmospheric pressure before the actuating the pump to withdraw the first and second liquids through the channel, wherein the pressure manifold continues to provide the pressure above the atmospheric pressure during the actuating the pump to withdraw the first and second liquids through the channel.

Aspect 4. The method of Aspect 1, wherein the pressure manifold provides the pressure above the atmospheric pressure at a same time as the actuating the pump to withdraw the first and second liquids through the channel.

Aspect 5. The method of any one of Aspects 1-4, wherein the attaching to the inlet reservoir the pressure manifold forms a sealing attachment between the inlet reservoir and the pressure manifold.

Aspect 6. The method of any one of Aspects 1-5, further comprising moving at least 90% or more of the second liquid from the channel so that the channel contains a gas from the pressure manifold. In other aspects, 50%, 60%, 70%, 80%, 90%, 95%, or 99% or more of the second liquid can be moved from the channel so that the channel contains a gas from the pressure manifold.

Aspect 7. The method of any one of Aspects 1-6, wherein the first liquid forms a plurality of bubbles in the channel, wherein the actuating the pump to withdraw at least the portion of the first liquid from the channel causes a portion of the plurality of bubbles in the channel to flow out of the outlet.

Aspect 8. The method of Aspect 7, wherein the portion of the plurality of bubbles ranges from about 50% to 100%. Using the combination of the actuating the pump to withdraw the liquid and the pressure manifold to provide the pressure above the atmospheric pressure improved the yield for removing the bubbles in an efficient manner. For various reasons, removing bubbles from the channel can be difficult by flushing liquid through the channel using only the pressure manifold or only the pump.

Aspect 9. The method of any one of Aspects 1-8, wherein the first liquid comprises a plurality of cells in the channel, wherein the actuating the pump to withdraw at least the portion of the first liquid from the channel causes a portion of the plurality of cells in the channel to flow out of the outlet.

Aspect 10. The method of Aspect 9, wherein the portion of the plurality of cells ranges from about 50% to 100%. Using the combination of the actuating the pump to withdraw the liquid and the pressure manifold to provide the pressure above the atmospheric pressure improved the yield for removing cells in an efficient manner, which was an unexpected result. For various reasons, removing cells from the channel can be difficult by flushing liquid through the channel using only the pressure manifold or only the pump.

Aspect 11. The method of any one of Aspects 1-10, wherein the pump creates a vacuum during the actuating the pump to withdraw at least the portion of the first liquid from the channel.

Aspect 12. The method of any one of Aspects 1-11, wherein the pump comprises a syringe pump.

Aspect 13. The method of any one of Aspects 1-12, wherein the moving of at least the portion of the second liquid occurs for a predetermined duration such that the second liquid in the inlet reservoir is not emptied.

Aspect 14. The method of any one of Aspects 1-12, wherein the moving of at least the portion of the second liquid occurs for a time duration such that the first and second liquids pass through the channel leaving the channel filled with air.

Aspect 15. The method of any one of Aspects 1-14, wherein the provided pressure from the pressure manifold is greater than one times atmospheric pressure, but less than five times atmospheric pressure.

Aspect 16. The method of any one of Aspects 1-14, wherein the provided pressure from the pressure manifold and the atmospheric pressure have a difference ranging from about 2 pounds per square inch and about 5 pounds per square inch.

Aspect 17. A method of delivering reagents to a cell analysis system comprising: providing a fluidic device comprising:

(i) a channel comprising an inlet and an outlet;

(ii) a spatial energy modulating element in optical communication with the channel;

(iii) a detector that identifies positions of one or more cells in the channel based on one or more optical signals therefrom,
wherein the inlet of the channel is in fluid communication with an inlet reservoir, and wherein the outlet of the channel is in fluid communication with a pump configured to move predetermined volumes of a liquid from the inlet reservoir through the channel;
   loading the inlet reservoir with a mixture of the one or more cells and one or more polymer precursors;
   sealingly attaching a pressure manifold to the inlet reservoir to pressurize the mixture to an elevated pressure greater than an ambient pressure; and
   moving the mixture into the channel with the pump so that the one or more cells of the mixture are disposed in the channel;
   synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein a location for each of the synthesized chambers is determined by the position identified by the detector.

Aspect 18. The method of Aspect 17, wherein the mixture comprises a first liquid, wherein after the synthesizing the one or more chambers in the channel, a portion of the one or more cells are disposed in an interstitial space outside of the chambers, the method further comprising:

loading the inlet reservoir with a second liquid;
sealingly attaching the pressure manifold to the inlet reservoir to pressurize the second liquid to the elevated pressure greater than the ambient pressure, and
moving the second liquid into the channel with the pump, so that a fraction of cells disposed in the interstitial space flows out of the channel via the outlet.

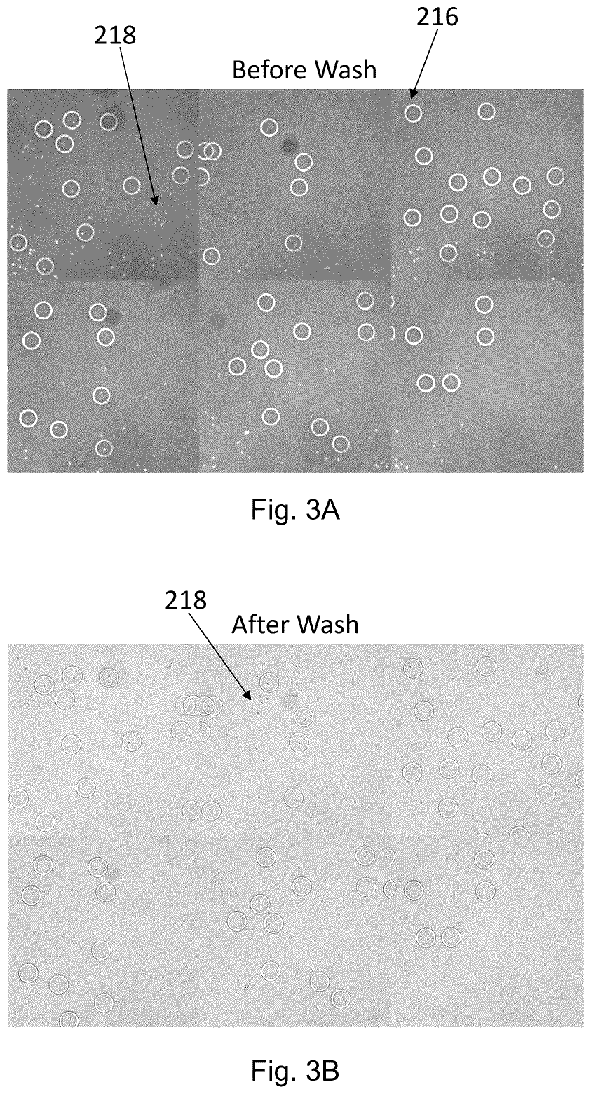

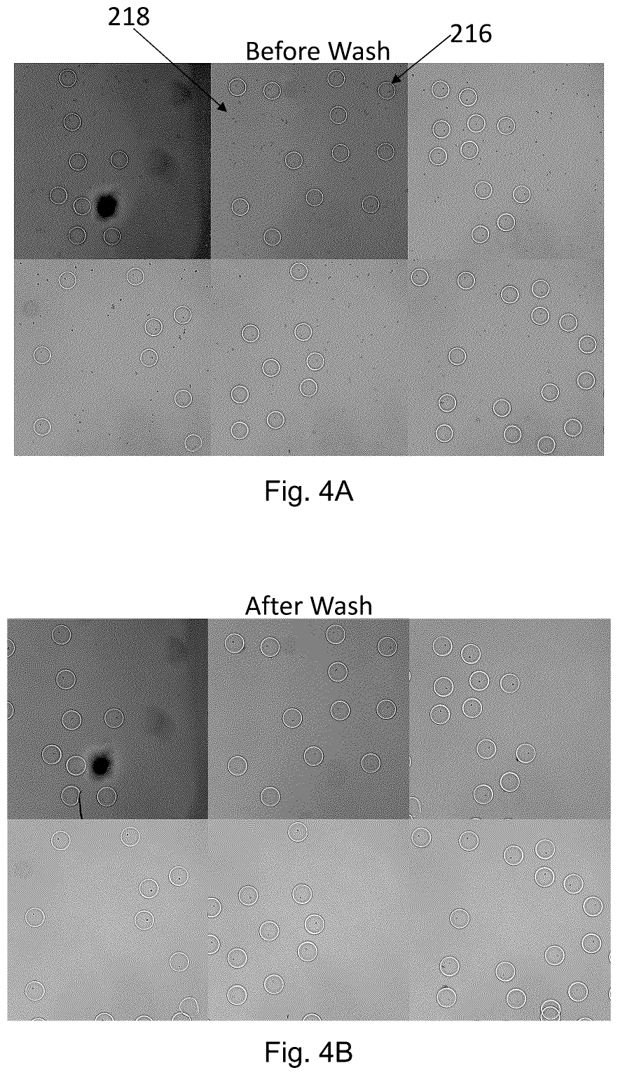

Aspect 19. The method of Aspect 18, wherein the fraction of cells in the interstitial space ranges from about 50% to 100%. FIG. 3A shows various cells where some are caged into hydrogel structures (216) and other cells (e.g., 218) are not caged and reside in the interstitial space in between the hydrogel structures. FIG. 3B shows the channel after flushing with a second liquid where the pressure manifold was not used to pressurize the second liquid and only the pump was used to move the liquid by pulling liquid from the outlet. FIG. 3B shows that a significant amount of remaining cells (e.g., 218) are in the interstitial space compared to FIG. 3A before washing of the channel. FIG. 4A shows various cells where some are caged into hydrogel structures (216) and other cells (e.g., 218) are not caged and reside in the interstitial space in between the hydrogel structures. FIG. 4B shows the channel after flushing with a second liquid where the pressure manifold was used to pressurize the second liquid while the pump was used to move the liquid by pulling liquid from the outlet. FIG. 4B shows that a relatively small amount of remaining cells are in the interstitial space, which contrasts to the higher amount of remaining cells where no pressure manifold was used as shown in FIG. 3B. It should be noted that cells and hydrogel structures, under certain conditions, can be fragile with respect to flowing liquids and that the flushing with the pressure manifold and the pump pulling liquid from the outlet resulted in benign conditions that did not perturb the hydrogel and at the same time resulted in an efficient removal of interstitial cells.

Aspect 20. The method of any one of Aspects 18-19, wherein the first liquid forms a plurality of bubbles in the interstitial space in the channel, wherein the moving the second liquid into the channel with the pump, so that a portion of the plurality of bubbles disposed in the interstitial space flows out of the channel via the outlet.

Aspect 21. The method of Aspect 20, wherein the portion of the plurality of bubbles ranges from about 50% to 100%.

Aspect 22. The method of any one of Aspects 17-21, wherein the pump creates a vacuum at the outlet during the moving the mixture into the channel.

Aspect 23. The method of any one of Aspects 18-21, wherein the pump creates a vacuum at the outlet during the moving the second liquid into the channel.

Aspect 24. The method of any one of Aspects 17-23, wherein the pump comprises a syringe pump.

Aspect 25. The method of any one of Aspects 18-24, wherein the moving of the second liquids occurs for a time duration such that the first and second liquids pass through the channel leaving the channel filled with air.

Aspect 26. The method of any one of Aspects 17-25, wherein the elevated pressure is greater than one times atmospheric pressure, but less than five times atmospheric pressure.

Aspect 27. The method of any one of Aspects 17-25, wherein the elevated pressure from the pressure manifold and the ambient pressure have a difference ranging from about 2 pounds per square inch and about 5 pounds per square inch.

Aspect 28. The method of any one of Aspects 17-27, wherein the sealingly attaching the pressure manifold to the inlet reservoir to pressurize the mixture to the elevated pressure greater than the ambient pressure occurs before the moving the mixture into the channel with the pump.

Aspect 29. The method of any one of Aspects 17-27, wherein the sealingly attaching the pressure manifold to the inlet reservoir to pressurize the mixture to the elevated pressure greater than the ambient pressure occurs before the moving the mixture into the channel with the pump, wherein the pressure manifold continues to provide the elevated pressure during the moving the mixture into the channel with the pump

Aspect 30. The method of any one of Aspects 18-29, further comprising: removing at least 90% or more of the second liquid from the channel so that the channel contains a gas from the pressure manifold.

Aspect 31. A fluid delivery system, comprising:

one or more reaction channels each containing a first liquid and having an outlet and an inlet, wherein an inlet reservoir is fluidically coupled to the inlet;
a pump in fluid communication with the outlet of the one or more reaction channels, wherein the pump is configured to move a liquid through the channel at a predetermined rate;
one or more supply reservoirs containing liquids in contact with atmosphere;
a pipettor for transferring a second liquid from the one or more supply reservoirs to the inlet reservoirs; and
a pressure manifold that is sealingly attached to the inlet reservoirs, wherein the pressure manifold is configured to apply a predetermined pressure above atmosphere to the first and second liquids.

Aspect 32. A method of delivering reagents to a cell analysis system, comprising:

providing a fluidic device comprising a channel comprising an inlet, an outlet, and a surface having one or more cells disposed thereon, wherein the inlet of the channel is in fluid communication with an inlet reservoir, and wherein the outlet of the channel is in fluid communication with a pump configured to move predetermined volumes of liquid from the inlet reservoir into the channel;

loading the inlet reservoir with an assay reagent in contact with atmosphere;

sealingly attaching a pressure manifold to the inlet reservoir to pressurize the assay reagent at an elevated pressure greater than an ambient pressure; and

moving the assay reagent through the channel with the pump so that the assay reagent contacts the one or more cells disposed on the surface of the channel.

Aspect 33. A method of delivering reagents to a cell analysis system, comprising: providing a fluidic device comprising
(i) a channel comprising an inlet, an outlet, and a surface having one or more cells disposed thereon,
(ii) a spatial energy modulating element in optical communication with the surface,
(iii) a detector that identifies positions of the one or more cells in the channel based on one or more optical signals therefrom,
   wherein the inlet of the channel is in fluid communication with an inlet reservoir, and
wherein the outlet of the channel is in fluid communication with a pump configured to move predetermined volumes of liquid from the inlet reservoir into the channel;

loading the inlet reservoir with a liquid comprising one or more polymer precursors, sealingly attaching a pressure manifold to the inlet reservoir to pressurize the liquid at an elevated pressure greater than an ambient pressure, and moving the liquid through the channel with the pump; and

synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein a location for each of the synthesized chambers on the surface is determined by the position, identified by the detector.

Aspect 34. A method of delivering reagents to a cell analysis system, comprising:

providing a fluidic device comprising a channel comprising an inlet, an outlet, and a surface having one or more cells disposed thereon, wherein the inlet of the channel is in fluid communication with an inlet reservoir, and wherein the outlet of the channel is in fluid communication with a pump configured to move predetermined volumes of liquid from the inlet reservoir into the channel;

loading the inlet reservoir with an assay reagent in contact with atmosphere; sealingly attaching a pressure manifold to the inlet reservoir to pressurize the assay reagent at an elevated pressure greater than an ambient pressure; and

moving the assay reagent through the channel with the pump, so that the assay reagent contacts the one or more cells disposed on the surface of the channel.

Aspect 35. The method of Aspect 34, further comprising incubating the one or more cells in the assay reagent for a predetermined time.

Aspect 36. The method of Aspect 34, wherein each of the one or more cells is enclosed by a hydrogel chamber.

Aspect 37. The method of any one of the preceding Aspects, wherein the pressure manifold comprises a conduit, the conduit including a single gas input port and a plurality of gas output ports, wherein the plurality of gas output ports are in fluid communication with the single gas input port.

Aspect 38. The method of any one of the preceding Aspects, wherein the pressure manifold comprises a conduit, the conduit including a single gas input port and a plurality of gas output ports.

Aspect 39. A method for moving a liquid through a channel, the method comprising:

(a) providing the channel having an outlet and an inlet,

wherein an inlet reservoir is fluidically coupled to the inlet, the channel containing a first liquid and being in fluid communication with the outlet, wherein a pump is fluidically coupled to the outlet, the pump being configured to move the liquid through the channel;

(b) attaching to the inlet reservoir a pressure manifold that provides a pressure above atmospheric pressure to the first liquid;

(c) actuating the pump to withdraw at least 90% or more of the first liquid from the channel via the outlet and to move a gas from the pressure manifold into the channel, wherein the pump was programmed to move fluid at a predetermined rate while under the provided pressure;

(d) transferring a second liquid to the inlet reservoir, wherein the transferred second liquid is in contact with an atmosphere;

(e) attaching to the inlet reservoir the pressure manifold that provides the pressure above atmospheric pressure to the second liquid; and

(f) actuating the pump to withdraw at least a portion of the gas from the channel via the outlet and to move at least a portion of the second liquid into the channel, wherein the pump was programmed to move fluid at the predetermined rate while under the provided pressure.

Aspect 40. The method of Aspect 39, wherein the pressure manifold provides the pressure above the atmospheric pressure before the actuating the pump to withdraw the gas from the channel.

Aspect 41. The method of Aspect 39, wherein the pressure manifold provides the pressure above the atmospheric pressure before the actuating the pump to withdraw the gas from the channel, wherein the pressure manifold continues to provide the pressure above the atmospheric pressure during the actuating the pump to withdraw at least a portion of the gas from the channel.

Aspect 42. The method of any one of Aspects 39-41, wherein the attaching to the inlet reservoir the pressure manifold forms a sealing attachment between the inlet reservoir and the pressure manifold.

Aspect 43. The method of any one of Aspects 39-42, wherein the pump creates a vacuum during the actuating the pump to withdraw at least the portion of the gas or the first liquid from the channel.

Aspect 44. The method of any one of Aspects 39-43, wherein the pump comprises a syringe pump.

Aspect 45. The method of any one of Aspects 39-44, wherein the provided pressure from the pressure manifold is greater than one times atmospheric pressure, but less than five times atmospheric pressure.

Aspect 46. The method of any one of Aspects 39-44, wherein the provided pressure from the pressure manifold and the atmospheric pressure have a difference ranging from about 2 pounds per square inch and about 5 pounds per square inch.

Aspect 47. The method of any one of the preceding Aspects, wherein the pressure manifold outputs a gas to provide the pressure, wherein the gas is selected from a group consisting of air, carbon dioxide, nitrogen, argon, and combinations thereof.

Aspect 48. The method of any one of the preceding Aspects, wherein the pressure manifold outputs a gas to provide the pressure, wherein the gas contains 5% carbon dioxide and the second liquid comprises a cellular media equilibrated with 5% carbon dioxide such that a pH of the cellular media does not change by more than 10%.

Aspect 49. The method of any one of the preceding Aspects, wherein the pressure manifold outputs a gas to provide the pressure, wherein the gas contains nitrogen or argon and the second liquid comprises an anaerobic cells or anaerobic organisms.

Aspect 50. The method of any one of the preceding Aspects, wherein the pressure manifold provides the pressure for a predetermined time duration above the atmospheric pressure before the actuating the pump to withdraw at least a portion of the first or the second liquids from the channel, The predetermined time duration can range from 5 minutes to 1 day. The pressure manifold providing the pressure for a predetermined time duration causes a reduction in the formation of bubbles during the predetermined time duration compared to the situation where no pressure manifold was used.

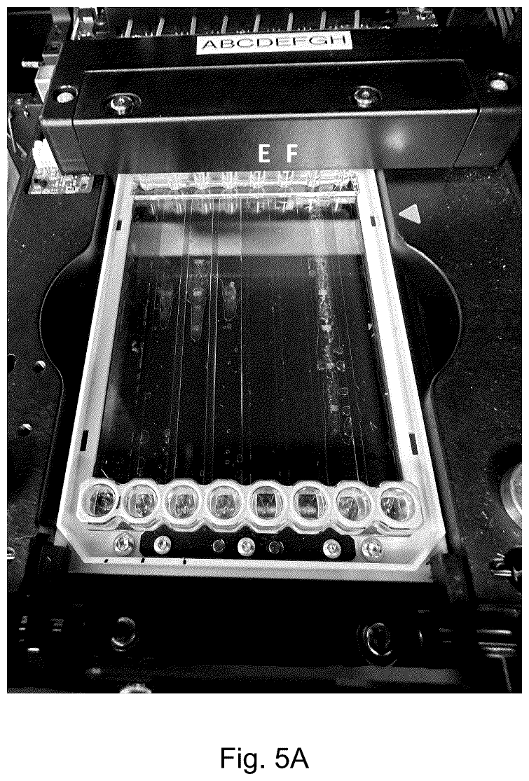

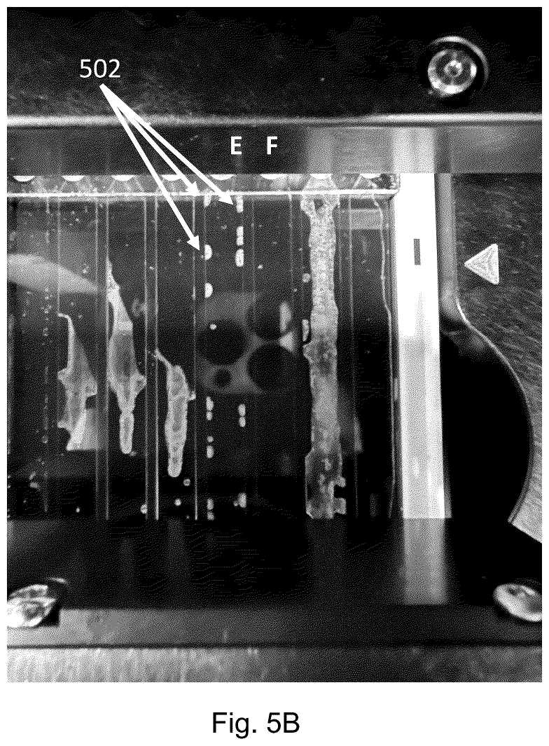

Aspect 51. A method for incubating a liquid in a channel, comprising: (a) providing the channel having an outlet and an inlet, wherein an inlet reservoir is fluidically coupled to the inlet, the channel containing a first liquid and being in fluid communication with the outlet, wherein a pump is fluidically coupled to the outlet, the pump being configured to move the liquid through the channel; (b) attaching to the inlet reservoir a pressure manifold that provides a pressure above atmospheric pressure to the first liquid, wherein the pump is not actuated causing the outlet to be sealed and the liquid to be quiescent, FIG. 5A shows a flow cell having channels E and F where the liquid in the channels were relatively bubble free. Channel F was pressurized with the pressure manifold at 5 PSI at the inlet reservoir and the outlet was closed for 90 minutes at 42° C. Channel E was left at atmospheric pressure for 90 minutes at 42° C. FIG. 5B indicates that after 90 minutes channel F remained relatively bubble free and that channel E had a plurality of bubbles 502. Thus, the channel with applied pressure from the manifold helped reduce the formation of bubbles over a time period and at elevated temperatures.

### Definitions

Unless otherwise specifically defined herein, terms and symbols of nucleic acid chemistry, biochemistry, genetics, and molecular biology used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Abbas et al, Cellular and Molecular Immuology, 6^{th} edition (Saunders, 2007).

“Assay” refers to a process for detecting or measuring a cellular characteristic or property of single cells or of a population of cells. Typically process steps of an assay comprise a chemical, biochemical or molecular reaction (such as a cleavage of a bond, specific binding of complementary components, enzyme reactions, dissolution of complementary components, or the like) or a change of physical state (such as an increase or decrease in temperature, change in energy level, or the like) and result in the generation of a signal (or signals) from which the presence, absence or magnitude of a quantity related to a cell may be inferred. The nature of the signal produced by an assay may vary widely and can include, but is not limited to, an electrical signal, an optical signal, a chemical signal, or a material signal. A material signal comprises the production of a material that comprises information that can be extracted. For example, a material signal may be the amplification of a polynucleotide whose length, quantity, composition, or nucleotide sequence is indicative of a cellular characteristic. For example, a barcode oligonucleotide may be a material signal. Characteristics or properties of cells that are detected or measured may vary widely and include, but are not limited to, cytotoxicity, viability, proliferation capacity under selected conditions, size, shape, motility, types and profiles of cell surface, or cell membrane proteins, types and profiles of secreted proteins, production of metabolites, transcriptome, gene copy numbers, gene or allele identity, chromatin accessibility profiles, vector copy numbers for engineered or infected cells, and the like. Assays of special interest for cell-based therapy include, but are not limited to, cytotoxicity, viability, activation, proliferation capacity under selected conditions, chromatin accessibility profiles, types and profiles of cell surface or membrane proteins, types and profiles of secreted proteins, intracellular proteins, transcriptome, vector copy number, and the like. As used herein, an “assay reagent” is a liquid used in an assay. An assay reagent may include, but is not limited to, a pH buffered solution, an enzyme buffer solution with or without an enzyme, a molecular or cellular stain or dye, a lysing agent, a gel degradation reagent, a suspension of cells, a salt solution, a wash solution, cellular growth media, or the like.

“Cells” refers to biological cells that may be assaved by methods and systems described herein comprise, but are not limited to, vertebrate, non-vertebrate, eukaryotic, mammalian, microbial, protozoan, prokaryotic, bacterial, insect, or fungal cells. In some embodiments, mammalian cells are assaved by methods and systems described herein. In particular, any mammalian cell which may be, or has been, genetically altered for use in a medical, industrial, environmental, or remedial process, may be analyzed by methods and systems described herein. In some embodiments, “cells” as used herein comprise genetically modified mammalian cells. In some embodiments, “cells” comprise stem cells. In some embodiments, “cells” refer to cells modified by CRISPR Cas9 techniques. In some embodiments, “cells” refer to cells of the immune system including, but not limited to, cytotoxic T lymphocytes, regulatory T cells, CD4+ T cells, CD8+ T cells, natural killer cells, antigen-presenting cells, or dendritic cells. Of special interest are cytotoxic T lymphocytes engineered for therapeutic applications, such as cancer therapy.

“Hydrogel” means a gel comprising a crosslinked hydrophilic polymer network with the ability to absorb and retain large amounts of water (for example, 60 to 90 percent water, or 70 to 80 percent) without dissolution due to the establishment of physical or chemical bonds between the polymeric chains, which may be covalent, ionic or hydrogen bonds. Hydrogels exhibit high permeability to the oxygen and nutrients, making them attractive materials for cell encapsulation and culturing applications. Hydrogels may comprise natural or synthetic polymers and may be reversible (i,e, degradable or depolymerizable) or irreversible. Synthetic hydrogel polymers can include polyethylene glycol (PEG), poly(2-hydroxyethyl methacrylate) and poly(vinyl alcohol). Natural hydrogel polymers can include alginate, hyaluronic acid and collagen. The following reference describe hydrogels and their biomedical uses: Drury et al, Biomaterials, 24: 4337-4351 (2003); Garagorri et al, Acta Biomatter, 4(5); 1139-1147 (2008); Caliari et al, Nature Methods, 13(5): 405-414 (2016); Bowman et al, U.S. Pat. No. 9,631,092; Koh et al, Langmuir, 18(7): 2459-2462 (2002).

“Polymer matrix” generally refers to a phase material (e,g, continuous phase material) that comprises at least one polymer. In some embodiments, the polymer matrix refers to the at least one polymer as well as the interstitial space not occupied by the polymer. A polymer matrix may be composed of one or more types of polymers. A polymer matrix may include linear, branched, and crosslinked polymer units. A polymer matrix may also contain non-polymeric species intercalated within its interstitial spaces not occupied by polymer chains. The intercalated species may be solid, liquid, or gaseous species. For example, the term “polymer matrix” may encompass desiccated hydrogels, hydrated hydrogels, and hydrogels containing glass fibers. A polymer matrix may comprise a polymer precursor, which generally refers to one or more molecules that upon activation can trigger or initiate a polymeric reaction. A polymer precursor can be activated by electrochemical energy, photochemical energy, a photon, magnetic energy, or any other suitable energy. As used herein, the term “polymer precursor” includes monomers (that are polymerized to produce a polymer matrix) and crosslinking compounds, which may include photo-initiators, other compounds necessary or useful for generating polymer matrices, especially polymer matrices that are hydrogels.

While preferred embodiments of the systems and methods described herein have been shown and described herein, it will be obvious to those skilled in the art that such embodiments are provided by way of example only. It is not intended that the systems and methods described herein be limited by the specific examples provided within the specification. While the systems and methods described herein have been described with reference to the aforementioned specification, the descriptions and illustrations of the embodiments herein are not meant to be construed in a limiting sense, Numerous variations, changes, and substitutions will now occur to those skilled in the art without departing from the systems and methods described herein. Furthermore, it shall be understood that all aspects of the systems and methods described herein are not limited to the specific depictions, configurations or relative proportions set forth herein which depend upon a variety of conditions and variables. It should be understood that various alternatives to the embodiments of the systems and methods described herein may be employed in practicing the systems and methods described herein. It is therefore contemplated that the systems and methods described herein shall also cover any such alternatives, modifications, variations or equivalents. It is intended that the following claims define the scope of the systems and methods described herein and that methods and structures within the scope of these claims and their equivalents be covered thereby.

What is claimed is:

1. A method for moving a liquid through a channel, the method comprising:
(a) providing the channel having an outlet and an inlet,
wherein an inlet reservoir is fluidically coupled to the inlet,
wherein the channel contains a first liquid, and
wherein a pump is fluidically coupled to the outlet;
(b) transferring a second liquid to the inlet reservoir, wherein the transferred second liquid is in contact with an atmosphere;
(c) attaching to the inlet reservoir a pressure manifold that provides a pressure above atmospheric pressure to the first and the second liquids; and
(d) actuating the pump to withdraw at least a portion of the first liquid from the channel via the outlet and to move at least a portion of the second liquid into the channel, wherein the pump is programmed to move fluid at a predetermined rate while under the pressure provided by the pressure manifold.

2. The method of claim 1, wherein the pressure manifold provides the pressure above the atmospheric pressure before the actuating in (d).

3. The method of claim 1, wherein the pressure manifold provides the pressure above the atmospheric pressure before the actuating in (d), and wherein the pressure manifold continues to provide the pressure above the atmospheric pressure during the actuating in (d).

4. The method of claim 1, wherein the pressure manifold provides the pressure above the atmospheric pressure at a same time as the actuating in (d).

5. The method of any one of claims 1-4, wherein in (c), a sealing attachment is formed between the inlet reservoir and the pressure manifold.

6. The method of any one of claims 1-5, further comprising: removing at least 90% or more of the second liquid from the channel so that the channel contains a gas from the pressure manifold.

7. The method of any one of claims 1-6, wherein the first liquid forms a plurality of bubbles in the channel, and wherein in (d), at least a portion of the plurality of bubbles in the channel flow out of the outlet.

8. The method of claim 7, wherein the portion of the plurality of bubbles ranges from about 50% to about 100% of the bubbles.

9. The method of any one of claims 1-8, wherein the first liquid comprises a plurality of cells in the channel, and wherein in (d), at least a portion of the plurality of cells in the channel flow out of the outlet.

10. The method of claim 9, wherein the portion of the plurality of cells ranges from about 50% to about 100% of the cells.

11. The method of any one of claims 1-10, wherein in (d), the pump creates a vacuum.

12. The method of any one of claims 1-11, wherein the pump comprises a syringe pump.

13. The method of any one of claims 1-12, wherein the moving of at least the portion of the second liquid occurs for a predetermined duration such that the second liquid in the inlet reservoir is not emptied.

14. The method of any one of claims 1-12, wherein the moving of at least the portion of the second liquid occurs for a time duration such that the first and second liquids pass through the channel, thereby leaving the channel filled with air.

15. The method of any one of claims 1-14, wherein the pressure provided by the pressure manifold is greater than one times atmospheric pressure, but less than five times atmospheric pressure.

16. The method of any one of claims 1-14, wherein the pressure provided by the pressure manifold and the atmospheric pressure have a difference ranging from about 2 pounds per square inch to about 5 pounds per square inch.

17. A method of delivering liquids to a cell analysis system, comprising:
(a) providing a fluidic device comprising:
(i) a channel comprising an inlet and an outlet;
(ii) a spatial energy modulating element in optical communication with the channel;
(iii) a detector that identifies positions of one or more cells in the channel based on one or more optical signals therefrom,
wherein the inlet of the channel is in fluid communication with an inlet reservoir, and
wherein the outlet of the channel is in fluid communication with a pump configured to move predetermined volumes of a liquid from the inlet reservoir through the channel;
(b) loading the inlet reservoir with a mixture of the one or more cells and one or more polymer precursors;
(c) sealingly attaching a pressure manifold to the inlet reservoir to pressurize the mixture to an elevated pressure greater than an ambient pressure;
(d) moving the mixture into the channel with the pump so that the one or more cells of the mixture are disposed in the channel; and
(e) synthesizing one or more chambers in the channel, such that each chamber encloses a single cell of the one or more cells, by projecting light into the channel with the spatial energy modulating element such that the projected light causes the one or more polymer precursors to form polymer matrix walls of the one or more chambers, wherein a location for each of the synthesized chambers is determined by the positions of the one or more cells identified by the detector.

18. The method of claim 17, wherein the mixture comprises a first liquid, wherein after the synthesizing in (e), a portion of the one or more cells are disposed in an interstitial space outside of the chambers, and wherein the method further comprises:
(f) loading the inlet reservoir with a second liquid;
(g) sealingly attaching the pressure manifold to the inlet reservoir to pressurize the second liquid to the elevated pressure greater than the ambient pressure, and
(h) moving the second liquid into the channel with the pump, so that a fraction of cells disposed in the interstitial space flow out of the channel via the outlet.

19. The method of claim 18, wherein the portion of the one or more cells in the interstitial space ranges from about 50% to about 100%.

20. A fluid delivery system comprising:
one or more reaction channels each containing a first liquid, wherein a reaction channel of the one or more reaction channels comprises an outlet and an inlet, wherein an inlet reservoir is fluidically coupled to the inlet;
a pump in fluid communication with the outlet, wherein the pump is configured to move a liquid through the channel at a predetermined rate;
one or more supply reservoirs containing a second liquid in contact with atmosphere;
a pipettor for transferring the second liquid from the one or more supply reservoirs to the inlet reservoir; and
a pressure manifold that is sealingly attached to the inlet reservoir, wherein the pressure manifold is configured to apply a pressure above atmospheric pressure to the first and second liquids.
